(19) United States
(12) Patent Application Publication
(10) Pub. No.: US 2026/0065323 A1
(43) Pub. Date: Mar. 5, 2026

(54) SERVER APPARATUS AND SYSTEM

(71) Applicant: TOYOTA JIDOSHA KABUSHIKI KAISHA, Toyota-shi (JP)

(72) Inventors: Takahiro TSUCHIYA, Toyota-shi (JP); Takashi FUJIWARA, Nagakute-shi (JP); Hirokazu KANO, Nagoya-shi (JP)

(73) Assignee: TOYOTA JIDOSHA KABUSHIKI KAISHA, Toyota-shi (JP)

(21) Appl. No.: 19/263,237

(22) Filed: Jul. 8, 2025

(30) Foreign Application Priority Data
Sep. 4, 2024 (JP) 2024-152355

(51) Int. Cl. G06Q 30/0251; B60K 35/85

(52) U.S. Cl. CPC G06Q 30/0265; B60K 35/85; B60K 2360/592

(57) ABSTRACT

A server apparatus includes a communication interface configured to make communication, a memory configured to store scenario information defining a proposal scenario to a user of a vehicle, and a controller configured to derive, using the scenario information, a proposal to the user based on attribute information indicating an attribute of the user and environmental information, and cause an in-vehicle apparatus of the vehicle to output or execute the proposal by transmitting, to the in-vehicle apparatus, proposal information indicating the proposal.

### CROSS-REFERENCE TO RELATED APPLICATION

This application claims priority to Japanese Patent Application No. 2024-152355, filed on Sep. 4, 2024, the entire contents of which are incorporated herein by reference.

### TECHNICAL FIELD

The present disclosure relates to a server apparatus and a system.

### BACKGROUND

When traveling by vehicle, users not only inform transportation service providers of destinations and other requests, but the service providers may also make various proposals to the users. Patent Literature (PTL) 1 discloses a system that supports a proposal by a transportation service provider.

### CITATION LIST

### Patent Literature

PTL 1: JP 7223513 B2

### SUMMARY

When making proposals to users of vehicles, there is room to match the proposals more precisely to the needs of the users.

A server apparatus and the like that can make a proposal that more precisely matches the needs of a user of a vehicle are disclosed below.

A server apparatus according to the present disclosure includes:
a communication interface configured to communicate with an in-vehicle apparatus mounted in a vehicle, and receive, from the in-vehicle apparatus, environmental information acquired by a sensor or a camera mounted in the vehicle;
a memory configured to store information indicating an attribute of a user of the vehicle and scenario information defining a proposal scenario to the user; and
a controller configured to derive, using the scenario information, a proposal to the user based on attribute information indicating the attribute and the environmental information, and cause the in-vehicle apparatus of the vehicle to output or execute the proposal by transmitting, to the in-vehicle apparatus, proposal information indicating the proposal.

A server apparatus according to another aspect of the present disclosure includes:
a communication interface configured to make communication;
a memory configured to store scenario information defining a proposal scenario to a user of a vehicle; and
a controller configured to derive, using the scenario information, a proposal to the user based on attribute information indicating an attribute of the user and environmental information, and cause an in-vehicle apparatus of the vehicle to output or execute the proposal by transmitting, to the in-vehicle apparatus, proposal information indicating the proposal.

A system according to the present disclosure includes:
an in-vehicle apparatus mounted in a vehicle; and
a server apparatus configured to communicate with the in-vehicle apparatus,
wherein
the server apparatus is configured to derive, using scenario information defining a proposal scenario to a user of the vehicle, a proposal to the user based on attribute information indicating an attribute of the user and environmental information, and transmit, to the in-vehicle apparatus of the vehicle, proposal information indicating the proposal, and
the in-vehicle apparatus is configured to output or execute the proposal.

According to a server apparatus and the like of the present disclosure, it is possible to make a proposal that more precisely matches the needs of a user of a vehicle.

### BRIEF DESCRIPTION OF THE DRAWINGS

In the accompanying drawings:

FIG. 1 is a diagram illustrating an example of a configuration of an information processing system;

FIG. 2 is a sequence diagram illustrating an example operation procedure of the information processing system;

FIG. 3 is a sequence diagram illustrating an example operation procedure of the information processing system; and

FIG. 4 is a diagram explaining a proposal scenario.

### DETAILED DESCRIPTION

An embodiment will be described below with reference to the drawings.

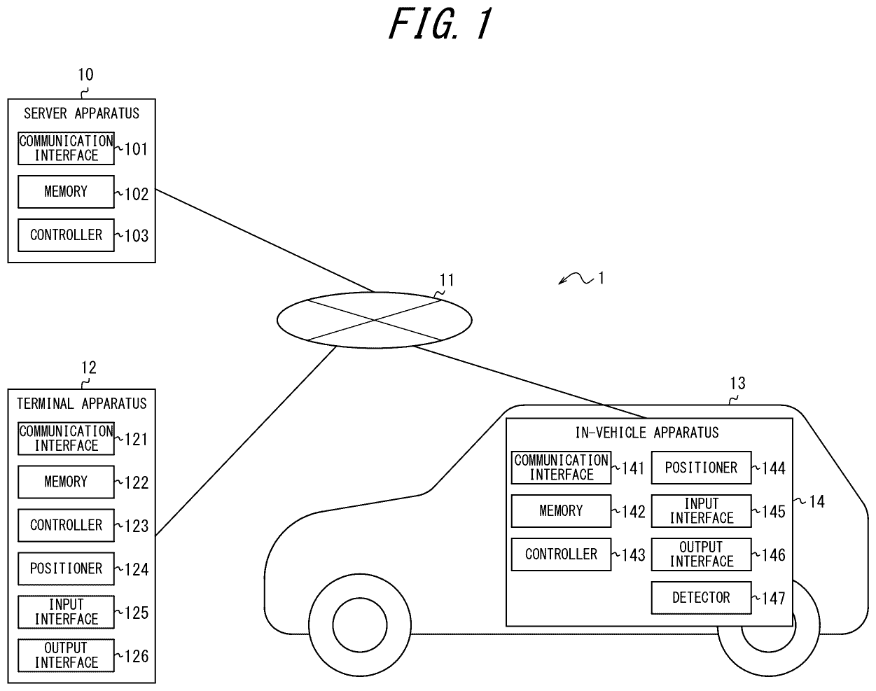

FIG. 1 is a diagram illustrating an example of a configuration of an information processing system according to the embodiment. An information processing system 1 includes at least one server apparatus 10, at least one terminal apparatus 12, and at least one in-vehicle apparatus 14 mounted in a vehicle 13, which are communicably connected to each other via a network 11. The server apparatus 10 is, for example, a server computer that belongs to a cloud computing system or another computing system, and functions as a server that implements various functions. The terminal apparatus 12 is an information processing terminal that exchanges various information with the server apparatus 10, and is, for example, a personal computer, a tablet terminal apparatus, or the like. The vehicle 13 is, for example, a passenger vehicle, a commercial vehicle, or the like. The in-vehicle apparatus 14 is, for example, a navigation system or the like that has communication and information processing functions. The network 11 is the Internet, for example, but may include an ad hoc network, a local area network (LAN), a metropolitan area network (MAN), other networks, or any combination thereof.

In the present embodiment, the information processing system 1 supports various proposals regarding travel to a user who travels using the vehicle 13. A person in charge of business providing the proposals makes settings regarding the proposals, to the server apparatus 10 using the terminal apparatus 12, and the server apparatus 10 transmits, to the in-vehicle apparatus 14, proposal information indicating the proposals. Specifically, the server apparatus 10 has a communication interface 101 that makes communication, a memory 102 that stores scenario information defining a proposal scenario for the user of the vehicle 13, and a controller 103. The controller 103 derives, using the scenario information, the proposals to the user based on attribute information indicating attributes of the user and environmental information, and causes the in-vehicle apparatus 14 to output or execute the proposals by transmitting, to the in-vehicle apparatus 14, proposal information indicating the proposals. The attribute information, which indicates the attributes of the user, and the environmental information, which indicates an environment of the vehicle, are highly probable to reflect the needs of the user, and the server apparatus 10 derives the proposals using the proposal scenario, which takes into account the attributes of the user and the environment of the vehicle, so it is possible to make the proposals that more precisely match the needs of the user.

Next, an example of a configuration of the server apparatus 10 will be described.

The server apparatus 10 includes a communication interface 101, a memory 102, and a controller 103. The server apparatus 10 may be a single computer or may be two or more computers that are communicably connected to each other and operate in cooperation. When the server apparatus 10 is configured with two or more computers, the configuration illustrated in FIG. 1 is arranged as appropriate on the two or more computers.

The communication interface 101 includes one or more interfaces for communication. The interfaces for communication include, for example, a LAN interface. The communication interface 101 receives information to be used for operations of the controller 103, and transmits information obtained by the operations of the controller 103. The server apparatus 10 is connected to the network 11 by the communication interface 101, and communicates information with the terminal apparatus 12 via the network 11.

The memory 102 includes, for example, one or more semiconductor memories, one or more magnetic memories, one or more optical memories, or a combination of at least two of these types, to function as a main memory, an auxiliary memory, or a cache memory. The semiconductor memories are, for example, random access memory (RAM) or read only memory (ROM). The RAM is, for example, static RAM (SRAM) or dynamic RAM (DRAM). The ROM is, for example, electrically erasable programmable ROM (EEPROM). The memory 102 stores the information to be used for the operations of the controller 103 and the information obtained by the operations of the controller 103.

The controller 103 includes one or more processors, one or more dedicated circuits, or a combination thereof. The processors are general purpose processors, such as central processing units (CPUs), or dedicated processors, such as graphics processing units (GPUs), specialized for particular processing. The dedicated circuits are, for example, field-programmable gate arrays (FPGAs), application specific integrated circuits (ASICs), or the like. The controller 103 executes information processing related to the operations of the server apparatus 10 while controlling components of the server apparatus 10.

The functions of the server apparatus 10 are realized by execution of a control program by a processor included in the controller 103. The control program is a program for causing a computer to execute processing of steps included in the operations of the server apparatus 10, thereby enabling the computer to realize functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10, and be read from the medium by the server apparatus 10.

Next, an example of a configuration of the terminal apparatus 12 will be described.

The terminal apparatus 12 includes a communication interface 121, a memory 122, a controller 123, a positioner 124, an input interface 125, and an output interface 126.

The communication interface 121 includes a communication module compliant with a wired or wireless LAN standard, a module compliant with a mobile communication standard such as long term evolution (LTE), 4th generation (4G), or 5th generation (5G), or the like. The terminal apparatus 12 connects to the network 11 via a nearby router apparatus or mobile communication base station using the communication interface 121, and communicates information with other apparatuses over the network 11.

The memory 122 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 122 functions as, for example, a main memory, an auxiliary memory, or a cache memory. The memory 122 stores information to be used for operations of the controller 123 and information obtained by the operations of the controller 123.

The controller 123 includes one or more processors, one or more dedicated circuits, or a combination thereof. The processors are general purpose processors such as CPUs or dedicated processors dedicated to specific processing. The dedicated circuits are, for example, FPGAs or ASICs. The controller 123 executes information processing related to operations of the terminal apparatus 12 while controlling components of the terminal apparatus 12.

The positioner 124 includes one or more global navigation satellite system (GNSS) receivers. The GNSS includes, for example, global positioning system (GPS), quasi-zenith satellite system (QZSS), BeiDou, global navigation satellite system (GLONASS), and/or Galileo. The positioner 124 transmits a positioning result to the controller 123, and the controller 123 calculates location information on the terminal apparatus 12.

The input interface 125 includes one or more interfaces for input. The interfaces for input include, for example, a microphone that accepts audio input, physical keys, capacitive keys, a pointing device, a touch screen integrally provided with a display, or the like. The input interface 125 accepts operations for inputting information to be used in the operations of the controller 123 and transmits the input information to the controller 123.

The output interface 126 includes one or more interfaces for output. The interfaces for output include, for example, a speaker or a display. The display is, for example, a liquid crystal display (LCD) or an organic electro-luminescence (EL) display. The output interface 126 outputs information obtained by the operations of the controller 123.

The functions of the controller 123 are realized by execution of a control/processing program by a processor included in the controller 123. The control/processing program is a program for causing a computer to execute processing of steps included in the operations of the controller 123, thereby enabling the computer to realize the functions corresponding to the processing of the steps. That is, the control/processing program is a program for causing a computer to function as the controller 123. Some or all of the functions of the controller 123 may be realized by a dedicated circuit included in the controller 123.

Next, an example of a configuration of the in-vehicle apparatus 14 will be described.

The in-vehicle apparatus 14 includes a communication interface 141, a memory 142, a controller 143, a positioner 144, an input interface 145, an output interface 146, and a detector 147. These components may be configured as a single control apparatus, as two or more control apparatuses, or with another apparatus such as a control apparatus and a communication device. The control apparatus includes, for example, an electronic control unit (ECU) or the like. The communication device includes, for example, a data communication module (DCM) or the like. The components are communicably connected to each other or to equipment in the vehicle 13, by an in-vehicle network compliant with a standard such as a controller area network (CAN). The in-vehicle apparatus 14 may be configured to include, in part, a device equivalent to the terminal apparatus 12.

The memory 142, the controller 143, the positioner 144, the input interface 145, and the output interface 146 have the same configurations as the memory 122, the controller 123, the positioner 124, the input interface 125, and the output interface 126 of the terminal apparatus 12, respectively.

The communication interface 141 includes one or more interfaces for communication. The interfaces for communication include, for example, an interface corresponding to a mobile communication standard, such as LTE, the 4G standard, or the 5G standard. The communication interface 141 receives information to be used for operations of the controller 143, and transmits information obtained by the operations of the controller 143. The controller 143 connects to the network 11 using the communication interface 141 through a mobile communication base station, and communicates information with other apparatuses via the network 11.

The detector 147 has interfaces with one or more sensors that detect states of various parts of the vehicle 13, or has the one or more sensors. The interfaces include an interface with a camera installed in the interior of the vehicle 13 to image the interior. The sensors include a vehicle speed sensor of the vehicle 13. The detector 147 transmits, to the controller 143, information such as a captured image and a vehicle speed.

The controller 143 controls each of the communication interface 141, the memory 142, the positioner 144, the input interface 145, the output interface 146, and the detector 147 while exchanging various information with these components, and also controls operations of the vehicle 13. When the vehicle 13 travels, the controller 143 presents, via the output interface 146, a driver with various information such as route information necessary for driving, to provide a navigation function, and controls automated driving of the vehicle 13.

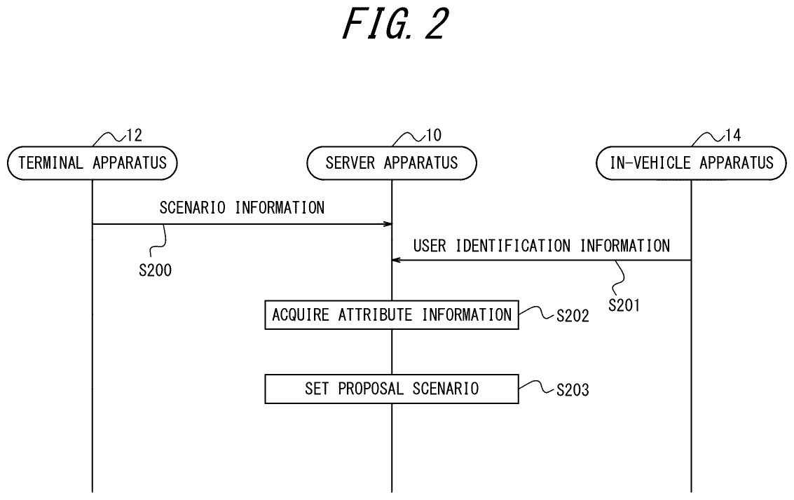

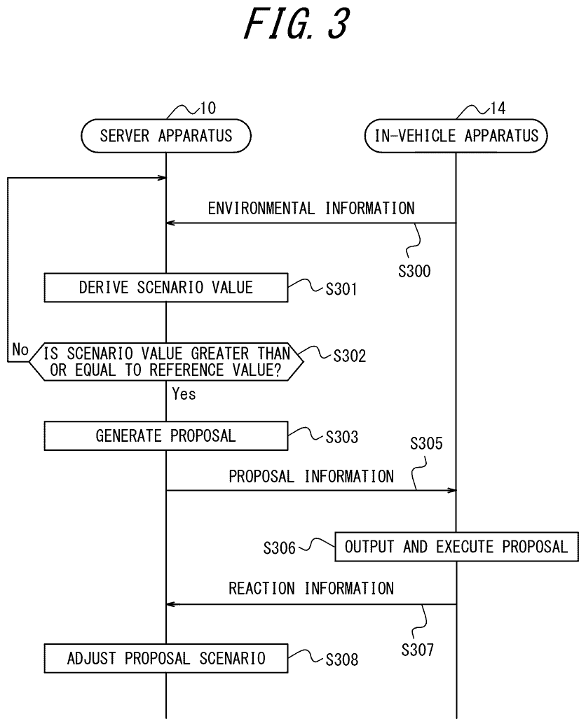

FIGS. 2 and 3 are sequence diagrams illustrating operation procedures of the information processing system 1 according to the present embodiment. FIG. 2 illustrates the procedure for ganged operations of the server apparatus 10, the terminal apparatus 12, and the in-vehicle apparatus 14, and FIG. 3 illustrates the procedure for ganged operations of the server apparatus 10 and the in-vehicle apparatus 14. The steps pertaining to various information processing by the server apparatus 10, the terminal apparatus 12, and the in-vehicle apparatus 14 in FIGS. 2 and 3 are performed by the respective controllers 103, 123, and 143. The steps pertaining to exchange of various information by the server apparatus 10, the terminal apparatus 12, and the in-vehicle apparatus 14 are performed by the respective controllers 103, 123, and 143 exchanging information with each other via the respective communication interfaces 101, 121, and 141. In the server apparatus 10, the terminal apparatus 12, and the in-vehicle apparatus 14, the respective controllers 103, 123, and 143 appropriately store the exchanged information in the respective memories 102, 122, and 142. Furthermore, the controllers 123 and 143 of the terminal apparatus 12 and the in-vehicle apparatus 14 accept input of various information from users by the respective input interfaces 125 and 145, and output various information to the users by the respective output interfaces 126 and 146.

FIG. 2 is an example procedure in which the server apparatus 10 acquires scenario information and attribute information on a user.

In S200, the terminal apparatus 12 transmits scenario information to the server apparatus 10. The scenario information is information that defines proposal scenarios for users who travel using vehicles 13. The proposal scenarios are scenarios that define when (timing) and what kind of information (target action, destination, or the like) is proposed with how to use parameters, such as attributes of drivers and environments of vehicles (conditions). For example, when the scenario information is input to the terminal apparatus 12 by an administrator, the terminal apparatus 12 transmits the scenario information to the server apparatus 10. The scenario information may include keywords, symbols, or the like to define the proposal scenarios, or may include natural language describing the proposal scenarios. The natural language describing the proposal scenarios may be, for example, “Guide a user with a child to a facility for children when no destination is set,” “Guide a user who likes pets to a facility where pets accompanying people are allowed when it takes considerable time to reach a destination,” and the like.

In S201, the server apparatus 10 acquires, from the in-vehicle apparatus 14, identification information on a user. The identification information on the user is ID information such as a username and a password to identify the user. The Identification information may include a name, age, address, and the like of the user. For example, when starting to use a proposal service, the user once operates the in-vehicle apparatus 14, and enters the identification information to transmit the identification information to the server apparatus 10.

In S202, the server apparatus 10 acquires attribute information on the user. The server apparatus 10 acquires the attribute information on the user from a server that provides a social network service (SNS) or a server that provides payment information on the user. The server apparatus 10 identifies information posted by each user in the SNS using the identification information on the user, and acquires the attribute information from the identified information. From the SNS postings, as well as information such as a gender, age, occupation, and the like of the user, information on family structure including the presence or absence, number, ages, genders, and the like of children, information on pets including the presence or absence, types, number, and the like of pets, information on preferred sports teams, music titles, movie titles, and the like, information on preferred outdoor locations such as ocean, mountains, or countryside, and the like are acquired. From this information, as well as the information such as the gender, age, occupation, and the like of the user, preference objects to which the user feels attachment, that is, children, pets, sports teams, music titles, movie titles, outdoor locations, and the like are acquired. From the payment information on the user, main spending targets of the user are acquired, and preference objects are acquired based on spending trends.

In S203, the server apparatus 10 sets a proposal scenario. The server apparatus 10 sets the proposal scenario using the scenario information and the attribute information on each user. The server apparatus 10, for example, analyzes the natural language included in the scenario information using a large-scale language model, and generates information necessary to set the proposal scenario. The large-scale language model may be stored in the server apparatus 10 or in another server with which the server apparatus 10 can communicate. The proposal scenario includes a weighted sum (hereafter referred to as scenario value) of elements, which include preference characteristic values of each user and environmental characteristic values in the vehicle 13 of that user. For example, as illustrated in the following Equation 1, the scenario value f(x, w) is the sum of the preference characteristic values and the environmental characteristic values for each user (x), weighted by coefficients w. Here, i represents the number of elements corresponding to the preference characteristic values, and j represents the number of elements corresponding to the environmental characteristic values. The types and number of the preference characteristic values and the types and number of the environmental characteristic values, which are used as the elements in the proposal scenario, are determined according to the attribute information.

$$f ( x , w ) = wi \times preference characteristic values + wj \times environmental characteristic values \qquad Equation 1$$

The preference characteristic value indicates, for example, the degree of preference of the user for each preference object. The preference characteristic value is, for example, the degree of preference for children, pets, specific sports, music, or the like. The degree of preference is indicated by a multi-level numerical value such that the greater the degree of preference, the greater the numerical value. The server apparatus 10 freely sets a coefficient w for the preference characteristic value, and adjusts, based on the attribute information, the level of the coefficient w for the preference characteristic value. For example, coefficients for elements corresponding to children, pets, sports, and the like included in the attribute information on the user are set larger than those for other elements. Furthermore, the server apparatus 10 may differentiate weighting coefficients among preference objects. For example, when the user has more posts for children than for pets, a coefficient for an element corresponding to children can be larger than a coefficient for an element corresponding to pets.

The environmental characteristic value indicates, for example, the degree of an event included in an environment of the vehicle 13. The event in the environment of the vehicle 13 includes an accessary power supply, travel speed, travel time, location information, a captured image of occupants, a set destination, or the like. The degree of the event is indicated by a multi-level numerical value according to the event. When the event is an accessary power supply, the degree is “1” for On and “0” for Off. When the event is the travel speed or travel time, the degree is a multi-level numerical value that is larger, the greater the travel speed or the travel time. When the event is the location information, the degree is a multi-level numerical value that is larger, the greater the distance from the set destination. When the event is the captured image of the occupants, the degree is “1” for the presence of a child or pet on board, and “0” for the absence of a child or pet. Furthermore, when the event is the set destination, the degree is “0” for a destination that matches the preferences of the user, and “1” for a destination that does not match the preferences of the user. The server apparatus 10 freely sets the coefficients w for the environmental characteristic values, and adjusts, based on the attribute information, the levels of the coefficients w. For example, in a case in which the preference objects include children, a coefficient for the degree “1” when the captured image of the occupants includes a child can be increased, or in a case in which the preference objects include pets, a coefficient for the degree “1” when the captured image of the occupants includes a pet can be increased. In a case in which the preference objects include sports, a coefficient for the degree of the set destination can be increased when the set destination is a facility related to sports, or in a case in which the preference objects include movies, a coefficient for the degree of the set destination can be increased when the set destination is a facility related to movies.

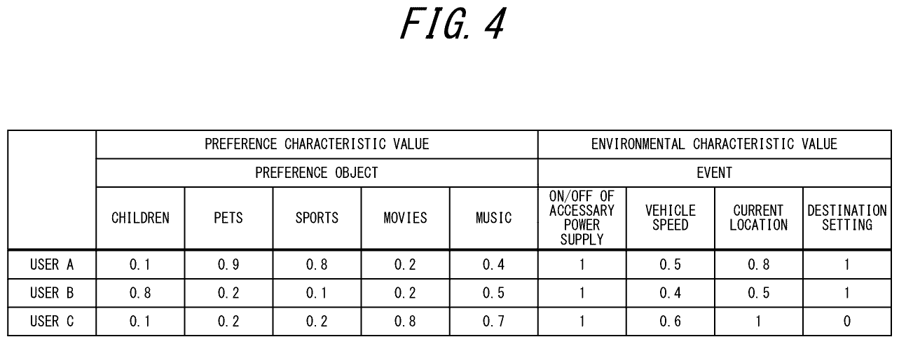

FIG. 4 illustrates an example of the preference characteristic values and the environmental characteristic values included in the proposal scenario. The table in FIG. 4 illustrates the example of three users, i.e., user A, user B, and user C. Here, the characteristic values for each of children, pets, sports, movies, and music, as the preference objects, and the characteristic values for each of ON/OFF of an accessary power supply, vehicle speed, current location, and destination setting, as the events included in the environment, are illustrated. For example, user A has relatively high preference characteristic values of “0.9” for pets and “0.8” for sports, which indicates that user A prefers pets and sports, and has a relatively high characteristic value of “0.8” for current location, which indicates such an environment that user A is located relatively far from a set destination so room for proposals is relatively large. User B has a prominently higher preference characteristic value of “0.8” for children than for the other preference objects, which indicates that user B prefers children, and has a moderate characteristic value of “0.5” for current location, which indicates such an environment that user B is at a moderate distance from a set destination so room for proposals is becoming smaller. Furthermore, while user C has low preference characteristic values for pets or children, user C has a prominently higher preference characteristic value of “0.8” for movies than for the other preference objects, which indicates that user C prefers movies, and since the destination setting is not made, as indicated by a characteristic value of “0,” room for proposals for a destination is large, as indicated by a characteristic value of “1” for current location.

In addition to the scenario value f(x, w), the proposal scenario may include factors (hereinafter referred to as “preference factors”) that affect preference tendencies, such as the age and gender of the user, which are obtained from the attribute information. The proposal scenario may also include information specifying a transmission destination of proposal information indicating proposals.

The proposal scenario is set through the procedure as in FIG. 2. Here, by using the scenario information transmitted by the administrator from the terminal apparatus 12, which takes into account fashion, trends in preferences of the user, and the like, the proposal scenario to make proposals that better match the preferences of the user is set. In addition, by weighting the elements of the proposal scenario using the attribute information, it is possible to execute proposals that better match the preferences of the user.

FIG. 3 is an example procedure in which the server apparatus 10 provides the user with a proposal by transmitting proposal information to the in-vehicle apparatus 14.

In S300, the server apparatus 10 acquires environmental information from the in-vehicle apparatus 14. In the in-vehicle apparatus 14, the controller 143 acquires various environmental information, and transmits the environmental information to the server apparatus 10 by the communication interface 141. The environmental information is information that indicates an environment in the vehicle 13. The environment includes events of an accessary power supply, travel speed, travel time, location information, a captured image of occupants, a set destination, and the like. For example, the in-vehicle apparatus 14 acquires the ON/OFF state of an accessary power supply, travel time, and the like from an electronic control unit (ECU) of the vehicle 13. The in-vehicle apparatus 14 also acquires a travel speed from a vehicle speed sensor. The in-vehicle apparatus 14 acquires location information using the positioner 144. The in-vehicle apparatus 14 acquires a captured image of occupants by an in-vehicle camera. The in-vehicle apparatus 14 acquires a destination entered by the user when a navigation function is activated. The acquisition of the environmental information by the in-vehicle apparatus 14 and the transmission of the environmental information to the server apparatus 10 are performed at any timing. For example, the acquisition and transmission may be executed at any cycle (e.g., a few second cycle) after the accessary power supply is turned on, or may be executed at any cycle with an internal battery or the like of the in-vehicle apparatus 14 even when the accessary power supply is off.

In S301, the server apparatus 10 derives a scenario value f(x, w). The scenario value is the weighted sum of the elements expressed in Equation 1 above, which includes the preference characteristic values of each user and the environmental characteristic values in the vehicle 13 of that user.

In S302, the server apparatus 10 determines whether the scenario value is greater than or equal to any reference value. When the scenario value is greater than or equal to the reference value (Yes), the operation proceeds to S303. When the scenario value is not greater than or equal to the reference value (No), the operation returns to S300 and performs S300 and S301 again.

In S303, the server apparatus 10 generates a proposal. The proposal is generated based on the proposal scenario. The proposal is, for example, an action related to a preference object of the user. For example, the proposal is to move to a destination that matches a preference object. When a destination has not yet been set, a new destination is proposed. When a destination has already been set, an alternative destination is proposed. The proposed destination is identified based on, for example, map information, information provided by other servers, or the like. For example, when the user has a preference for children, a play facility for children, a facility that allows admission with children, a store selling children's goods, or the like is proposed as a destination. When the user has a preference for pets, a facility that allows entry with pets, a store selling pet supplies, or the like is proposed as a destination. When the user has a preference for sports, a sports venue, a store selling sporting goods, or the like is proposed as a destination. When the user has a preference for outdoors, an outdoor location such as the ocean, mountains, or countryside is proposed as a destination. Alternatively, the proposal is an appreciation of a preference object. When the preference object is any music, the output of that music is proposed. When the destination is a place that is difficult to visit with children or pets, the server apparatus 10 may generate a proposal on condition that there are no such occupants included in the captured image.

Here, since the elements of the scenario value corresponding to the environmental information include the location information, the captured image of the occupants, the set destination, and the like, for example, when the current location is relatively far from the destination, when the preference object is on board the vehicle, or when the destination that matches the preference object is set, the scenario value becomes large and easily reaches the reference value in S302. Therefore, since the scenario value reaching the reference value is set as a condition for making a proposal, it is possible to make the proposal at a timing more suitable for the needs of the user, without bothering the user with uniform mechanical proposals. In addition, the proposal scenario may define, as a condition for making a proposal, that elapsed time since previous transmission of proposal information has reached any reference value.

In S305, the server apparatus 10 transmits, to the in-vehicle apparatus 14, proposal information indicating the proposal.

In S306, the in-vehicle apparatus 14 outputs or executes the proposal corresponding to the proposal information. For example, the in-vehicle apparatus 14 audibly outputs, to the user, information proposing a destination. Alternatively, the in-vehicle apparatus 14 audibly proposes the output of music to the user, and outputs the music in response to a voice input indicating the user's acceptance. Alternatively, the in-vehicle apparatus 14 may perform automated driving to a proposed destination based on the proposal information, under the condition of the user's acceptance.

In S307, the in-vehicle apparatus 14 transmits, to the server apparatus 10, reaction information indicating the user's reaction. The user's reaction is a positive or negative reaction to the proposal. The positive reaction is transmitted to the server apparatus 10 when the user sets the proposed destination or accepts the output of the music. On the other hand, the negative reaction is transmitted to the server apparatus 10 when the destination is not set within any reference time, or when the user's intention to disagree with the output of the music or a cessation of the output of the music is detected within any reference time. The user's intention for the proposal is determined, for example, based on speech. The in-vehicle apparatus 14 can perform speech recognition on the user's speech and determine, as a positive reaction or a negative reaction, when the speech contains keywords indicating acceptance or rejection, respectively.

In S308, the server apparatus 10 adjusts the proposal scenario using the user's reaction. For example, the server apparatus 10 increases the coefficient w for the preference characteristic value of the user upon receiving the positive reaction to the proposed destination, and decreases the coefficient w upon receiving the negative reaction. For example, upon obtaining a positive or negative reaction to a destination such as a facility for children, the server apparatus 10 adjusts the coefficient of the characteristic value for children as a preference object, and upon obtaining a positive or negative reaction to a destination such as a facility for pets, the server apparatus 10 adjusts the coefficient of the characteristic value for pets as a preference object. Upon obtaining a positive or negative reaction to a proposal for the output of music, the server apparatus 10 adjusts the coefficient of the characteristic value for the music as a preference object. The proposal scenario can be thereby adjusted to better match the needs of the user.

The proposal is made to the user through the procedure in FIG. 3. In addition, adjusting the proposal scenario using the reaction information makes it possible to make proposals that better match the preferences of the user.

In a variation, before S306, the server apparatus 10 determines a provision destination to which the proposal information indicating the proposal is provided. When an accessary power supply is on, the provision destination is the in-vehicle apparatus 14. Alternatively, when the accessary power supply is off, the provision destination is a terminal apparatus such as a smartphone used by the user. Such information on the terminal apparatus is stored in advance in the memory 102 of the server apparatus 10. The information on the provision destination according to the state of the accessary power supply is specified, for example, in the proposed scenario. The proposal can be transmitted to the smartphone or other device carried by the user, even before the user has boarded the vehicle 13, for example.

In another variation, preference factors such as the age and gender of the user may be taken into account in the proposal scenario. For example, when the server apparatus 10 selects a destination to be proposed, from multiple candidate destinations, it is possible to select a destination that is popular according to the user's age and gender, based on ranking information acquired from another server or the like. This makes it possible to meet the needs of the user more precisely.

The events included in the environment of the vehicle 13 may include an external temperature measured by a sensor, weather acquired from an information distribution server, and the like. The events included in the environment may be events at multiple points in time, including the past, as well as events at the present time. For example, the characteristic value of the external temperature is a score that becomes smaller, the more the external temperature deviates from a suitable temperature (e.g., 20° C. to 25° C.). The characteristic value of the weather is the largest for good weather (clear sky), and freely and stepwise becomes smaller for stormy weather (heavy rain, windstorms, and the like). The greater the difference between multiple points in time, the greater the weight may be assigned. The more favorable external temperature continues or the more favorable weather continues, the easier it is for the scenario value to reach the reference value, thus improving the frequency of providing proposals by the server apparatus 10 to the user.

According to the embodiment described above, it is possible to provide the user with proposals that more precisely match the preferences of the user of the vehicle 13.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A server apparatus comprising:
a communication interface configured to communicate with an in-vehicle apparatus mounted in a vehicle, and receive, from the in-vehicle apparatus, environmental information acquired by a sensor or a camera mounted in the vehicle;
a memory configured to store information indicating an attribute of a user of the vehicle and scenario information defining a proposal scenario to the user; and
a controller configured to derive, using the scenario information, a proposal to the user based on attribute information indicating the attribute and the environmental information, and cause the in-vehicle apparatus of the vehicle to output or execute the proposal by transmitting, to the in-vehicle apparatus, proposal information indicating the proposal.

2. A server apparatus comprising:
a communication interface configured to make communication;
a memory configured to store scenario information defining a proposal scenario to a user of a vehicle; and
a controller configured to derive, using the scenario information, a proposal to the user based on attribute information indicating an attribute of the user and environmental information, and cause an in-vehicle apparatus of the vehicle to output or execute the proposal by transmitting, to the in-vehicle apparatus, proposal information indicating the proposal.

3. The server apparatus according to claim 2, wherein the proposal scenario includes a weighted sum of elements that include a preference characteristic value for each user and an environmental characteristic value in the vehicle of that user.

4. The server apparatus according to claim 3, wherein the controller is configured to generate an equation to derive the weighted sum from the scenario information using a large-scale language model.

5. The server apparatus according to claim 3, wherein the preference characteristic value for each user includes a degree of preference of that user for a preference object derived from the attribute information on that user.

6. The server apparatus according to claim 5, wherein the environmental characteristic value in the vehicle of each user includes a value indicating whether the preference object of that user is on board, a value indicating a distance to a destination according to the preference object of that user, and a value indicating elapsed time from previous transmission of proposal information.

7. The server apparatus according to claim 3, wherein the controller is configured to transmit the proposal information on condition that the weighted sum has reached a reference value.

8. The server apparatus according to claim 2, wherein the controller is configured to transmit the proposal information by taking into account the attribute of the user.

9. The server apparatus according to claim 3, wherein the proposal scenario includes information indicating a condition for transmitting the proposal information to a terminal apparatus, instead of to the in-vehicle apparatus.

10. The server apparatus according to claim 2, wherein the controller is configured to receive, from the in-vehicle apparatus, information indicating a reaction to the proposal.

11. The server apparatus according to claim 10, wherein the controller is configured to modify the proposal scenario using the information indicating the reaction.

12. A system comprising:
an in-vehicle apparatus mounted in a vehicle; and
a server apparatus configured to communicate with the in-vehicle apparatus,
wherein
the server apparatus is configured to derive, using scenario information defining a proposal scenario to a user of the vehicle, a proposal to the user based on attribute information indicating an attribute of the user and environmental information, and transmit, to the in-vehicle apparatus of the vehicle, proposal information indicating the proposal, and
the in-vehicle apparatus is configured to output or execute the proposal.

13. The system according to claim 12, wherein the proposal scenario includes a weighted sum of elements that include a preference characteristic value for each user and an environmental characteristic value in the vehicle of that user.

14. The system according to claim 13, wherein the server apparatus is configured to generate an equation to derive the weighted sum from the scenario information using a large-scale language model.

15. The system according to claim 13, wherein the preference characteristic value for each user includes a degree of preference of that user for a preference object derived from the attribute information on that user.

16. The system according to claim 15, wherein the environmental characteristic value in the vehicle of each user includes a value indicating whether the preference object of that user is on board, a value indicating a distance to a destination according to the preference object of that user, and a value indicating elapsed time from previous transmission of proposal information.

17. The system according to claim 13, wherein the server apparatus is configured to transmit the proposal information on condition that the weighted sum has reached a reference value.

18. The system according to claim 12, wherein the server apparatus is configured to transmit the proposal information by taking into account the attribute of the user.

19. The system according to claim 13, wherein the proposal scenario includes information indicating a condition for transmitting the proposal information to a terminal apparatus, instead of to the in-vehicle apparatus.

20. The system according to claim 12, wherein the server apparatus is configured to receive, from the in-vehicle apparatus, information indicating a reaction to the proposal.
